(19) United States
(12) Patent Application Publication
(10) Pub. No.: US 2010/0005680 A1
(43) Pub. Date: Jan. 14, 2010

(54) DUCTLESS DRYER

(75) Inventors: Yang-Ho Kim, Changwon (KR); Seung-Phyo Ahn, Changwon (KR); Sang-Ik Lee, Changwon (KR); Byeong-Jo Ryoo, Changwon (KR); Sung-Ho Song, Changwon (KR); Han-Yong Jung, Changwon (KR); Jae-Hyuk Wee, Changwon (KR); Yoon-Seob Eom, Changwon (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/526,899

(22) PCT Filed: Feb. 13, 2008
(86) PCT No.: PCT/KR08/00833

§ 371 Date: Aug. 12, 2009

(30) Foreign Application Priority Data
Feb. 13, 2007 (KR) 10-2007-0015001

(51) Int. Cl. F26B 11/02

(52) U.S. Cl. 34/130

(57) ABSTRACT

A ductless dryer includes a sealing unit for preventing a leakage of lint through a gap of a filter installation portion. The sealing unit includes a sealing protrusion formed at the filter, a sealing recess disposed at a filter installation duct of the circulation duct for inserting the sealing protrusion thereinto, and a sealing member inserted into the sealing recess and contacting the sealing protrusion. Accordingly, the ductless dryer according to the present invention can prevent the leakage of lint through a gap of a filter installation portion and the malfunction of the ductless dryer by leaked lint, thereby enhancing reliability of the dryer.

### TECHNICAL FIELD

The present invention relates to a ductless dryer having a filter for filtering lint, and more particularly, to a ductless dryer which can prevent a leakage of lint through a gap of an installation position where a filter is installed.

### BACKGROUND ART

In general, a clothes dryer is a device that absorbs moisture from objects to be dried (load) by blowing hot air generated by a heater into a drum and thereby dries the load. Clothes dryers may be roughly categorized into an exhaust type clothes dryer and a condensation type clothes dryer, according to the method employed for handling the humid air occurring when absorbing the moisture and drying the load.

The exhaust clothes dryer employs a method for exhausting the humid air flowing from the drum to the outside of the dryer. However, it requires an exhaust duct for exhausting the moisture evaporated in the drum to the outside. In particular, the exhaust duct needs to be installed being extended long enough to the outdoors, considering that carbon monoxide, etc. as a product of combustion are also exhausted.

Meanwhile, the condensation type clothes dryer uses a recirculation method that removes moisture by condensing the moisture from the humid air flowing from the drum in a heat exchanger and then recirculates the moisture-removed dry air back into the drum. However, the drying air flow forms a closed loop, making it difficult to use gas as a heating source.

A ductless dryer overcomes the demerits of the exhaust type dryer and the condensation type dryer. That is, the ductless dryer can be maintained at a low cost by using gas as a heating source and does not require an additional exhaust duct to be extended to the outdoors.

Meanwhile, the above-mentioned ductless dryer includes a filter for filtering lint contained in the air coming out of the drum. However, in the related art ductless dryer, lint may be leaked through a gap of a portion where the filter is installed.

For instance, a screen filter is formed of a plastic material, and a portion where the screen filter is installed is formed of steel. Accordingly, due to such different materials, it is difficult to completely seal the screen filter and the installation portion of the screen filter, thereby causing the leakage of lint. A butterfly filter as another example also causes the leakage of lint due to the lack of a sealing structure of a portion where the butterfly filter is installed.

### DISCLOSURE OF THE INVENTION

### Technical Problem

### Technical Solution

To achieve these and other advantages and in accordance with the purpose of the present invention, as embodied and broadly described herein, there is provided a ductless dryer, including: a main body, a drum rotatably mounted at the main body; a hot air supplying unit for supplying hot air into the drum; a heat exchanger for removing moisture contained in air exhausted from the drum; a circulation duct conducting the air exhausted from the drum to the heat exchanger; a filter installed in the circulation duct for filtering lint contained in the air discharged from the drum; and a sealing unit preventing the leakage of lint through a gap of an installation portion where the filter is installed. Preferably, the sealing unit is respectively formed at the filter and the circulation duct.

Preferably, the sealing unit of the ductless dryer according to the present invention may include a sealing protrusion formed at the filter, a sealing recess disposed at a filter installation duct of the circulation duct for inserting the sealing protrusion thereinto, and a sealing member disposed between the sealing protrusion and the sealing recess when the sealing protrusion is inserted into the sealing recess.

The sealing unit of the ductless dryer according to another embodiment of the present invention may include a sealing protrusion formed at the filter installation duct of the circulation duct, a sealing recess disposed at the filter for inserting the sealing protrusion thereinto, and a sealing member disposed between the sealing protrusion and the sealing recess when the sealing protrusion is inserted into the sealing recess.

And, the sealing member may be mounted at the sealing protrusion or the sealing recess, or may be provided as a separate member.

Preferably, the sealing protrusion has an inclination surface contacting the sealing member, and teeth are formed on the inclination surface. In addition, preferably, an inclination surface is formed on a surface of the sealing recess facing the inclination surface of the sealing protrusion, and a plurality of sealing members are inserted into the sealing recess.

Preferably, the sealing member is provided with an upper protrusion portion contacting the sealing protrusion at an upper side thereof, and a lower protrusion portion contacting the sealing protrusion at a lower side thereof. Here, preferably, the sealing protrusion has an inclination surface contacting the sealing member, and an inclination angle of a line connecting each center of the upper and lower protrusion portions is the same as or greater than an inclination angle of the inclination surface.

In the ductless dryer according to still another embodiment of the present invention, the inclination surface of the sealing protrusion is formed at both side surfaces of the sealing protrusion, thereby enhancing a sealing effect. A plurality of sealing members may be provided at both side surfaces of the sealing recess. Further, preferably, an inclination surface is formed on a surface of the sealing recess facing the inclination surface of the sealing protrusion.

### BRIEF DESCRIPTION OF THE DRAWINGS

FIG. 1 is a schematic view of a ductless dryer according to one embodiment of the present invention;

FIG. 2 is a plane view of the ductless dryer in FIG. 1;

FIG. 3 is a rear view of the ductless dryer in FIG. 1;

FIG. 4 is a front view showing the state that a filter is installed at a filter installation duct in FIG. 1;

FIG. 5 is a side view showing the state that the filter is installed at the filter installation duct in FIG. 1;

FIG. 6 is a side cross-sectional view showing the state that the filter is installed at the filter installation duct in FIG. 1;

FIG. 7 is an enlarged view showing a sealed portion of the filter installation duct and the filter in FIG. 6;

FIG. 8 is an enlarged view showing a sealed portion of a filter installation duct and a filter according to another embodiment of the present invention;

FIG. 9 is an enlarged view showing a coupling protrusion in FIGS. 7 and 8;

FIG. 10 is a view showing that the coupling protrusion is inserted into a coupling hole where a sealing member in FIG. 7 is installed;

FIG. 11 is a view showing that the coupling protrusion is inserted into a coupling hole where a sealing member in FIG. 8 is installed;

FIG. 12 is an enlarged view showing a state that the coupling protrusion contacts the sealing member in FIG. 7; and

FIG. 13 is a view showing that an inclination surface is formed at the sealing recess according to another embodiment of the present invention.

### MODES FOR CARRYING OUT THE PREFERRED EMBODIMENTS

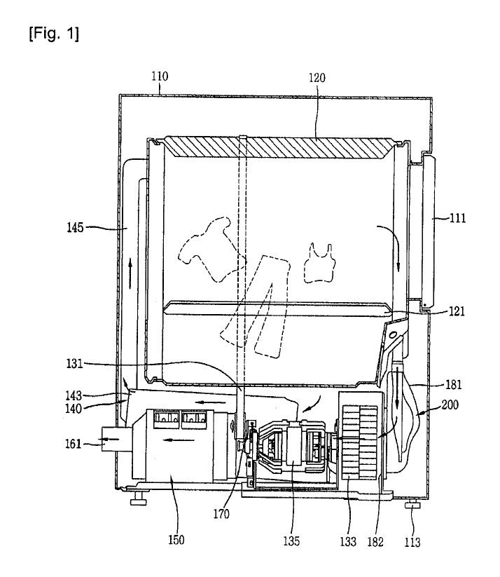

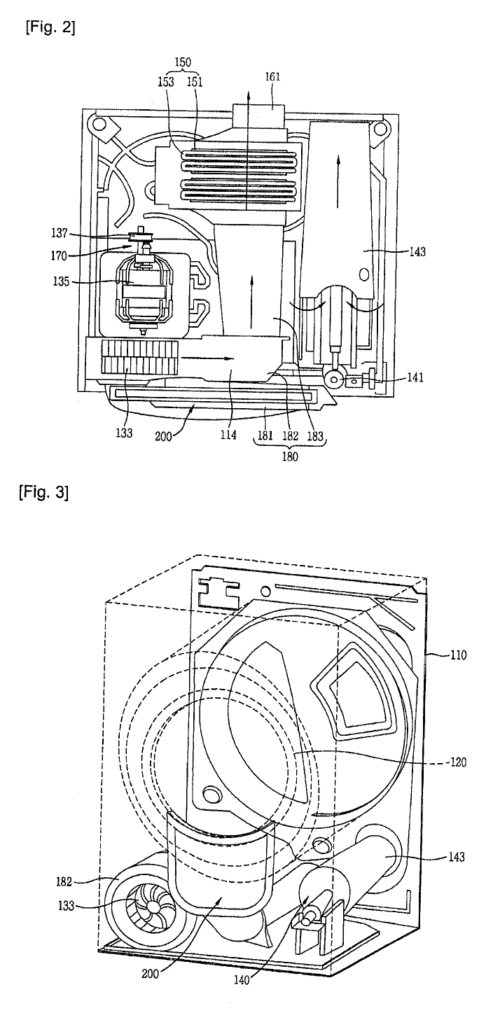

Description will now be given in detail of the ductless dryer according to one embodiment of the present invention, examples of which are illustrated in the accompanying drawings. FIG. 1 is a schematic view of a ductless dryer according to one embodiment of the present invention, FIG. 2 is a plane view of the ductless dryer in FIG. 1, and FIG. 3 is a rear view showing the ductless dryer in FIG. 1. Arrows indicate the flow of air.

Referring to FIGS. 1 through 3, the ductless dryer according to one embodiment of the present invention includes a main body 110; a drum 120 rotatably mounted at the main body 110; a hot air supplying unit 140 supplying hot air into the drum 120; a heat exchanger 150 removing moisture contained in the air exhausted from the drum 120; a circulation duct 180 conducting the air exhausted from the drum 120 to the heat exchanger 150; a filter 200 installed in the circulation duct 180 and filtering lint contained in the air coming out of the drum 120; and a sealing unit S preventing the leakage of lint through a gap of an installation portion where the filter 200 is installed.

A door 111 is mounted on a front surface of the main body 110 to enable loading of clothes into the drum 120. A foot 113 is disposed at a lower portion of the main body 110 to support the main body 110. A belt 131 for rotating the drum 120 and a motor 135 for supplying a driving force to the belt 131 are mounted inside the main body 110. A pulley 137 for winding the belt 131 is disposed on a shaft of the motor 135.

The drum 120 is a container having an inner space into which clothes, etc., as objects to be dried, can be loaded. A plurality of lifters 121 are installed inside the drum 120 so as to lift the clothes.

The hot air supplying unit 140 includes a valve 141 controlling the supplying of gas, a gas burner 143 mixing the gas supplied from the valve 141 with an air supplied from the outside, igniting it, and then generating hot air, and a hot air supplying duct 145 communicating the gas burner 143 with the drum 120 so as to supply the generated hot air to the drum 120. In order to indirectly determine the amount of carbon monoxide (CO) emissions through a numerical value of a flame current by detecting the flame current, a flame rod extending to an edge of a flame may be installed in the hot air supplying unit 140.

Preferably, the valve 141 is implemented as a solenoid valve so as to sensitively adjust the amount of gas supplied.

While being supplied by the valve 141, the gas burner 143 heats the air with the heat generated when the gas supplied from the valve 141 is mixed with the outside air and then burned. The hot air generated by being thusly heated is provided to the drum 120 through the hot air supplying duct 145.

The heat exchanger 150 includes fins 151 and a tube 153. The heat exchanger 150 condenses moisture from the air of high temperature and humidity coming out of the drum 120 through a heat exchange method of air to water by using water of low temperature, to thereby dry the air. An inlet of the heat exchanger 150 is connected to the drum 120 by the circulation duct 180, and an outlet thereof is connected to an exhaust duct 161.

The fins 151 are thin metallic plates having excellent thermal conductivity and are laminated as a plurality of thin vertical metallic plates having a minute distance therebetween so as to contact with the air of high temperature and humidity as it passes through.

Water of low temperature (22° C.) is circulated through the tube 153. The tube 153 penetrates the fins 151 in a serpentine manner. Both ends of the tube 153 are connected to water lines (not shown) for supplying and draining water of low temperature. A water container (not shown) for collecting condensed water, which is generated during the condensation process and dropped, is installed at a lower portion of the heat exchanger 150.

The circulation duct 180 includes a filter installation duct 181 providing a space where the filter 200 is installed, a fan installation duct 182 connected to the filter installation duct 181 and providing a space where the fan 133 is installed, and a connection duct 183 for connecting the fan installation duct 182 and the heat exchanger 150. Here, the fan 133 is connected to a shaft of the motor 135 and is supplied a driving force from the motor 135. To be certain, a plurality of motors 135 may be provided so as to respectively supply a driving force to the belt 131 and the fan 133.

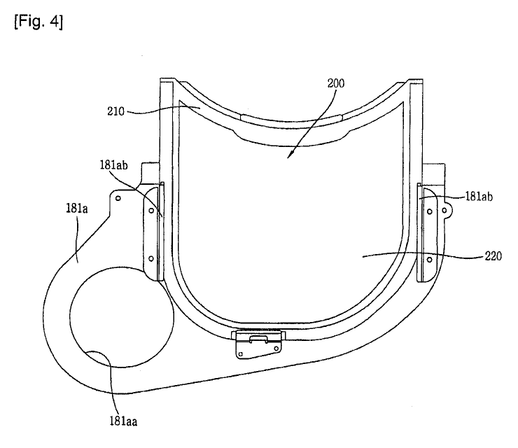

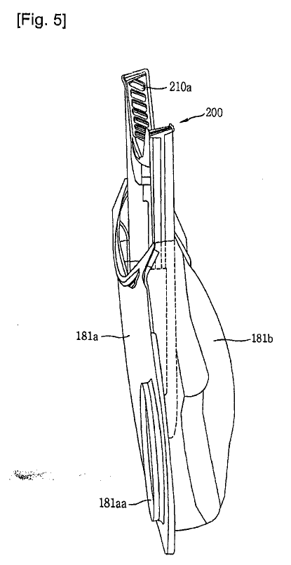

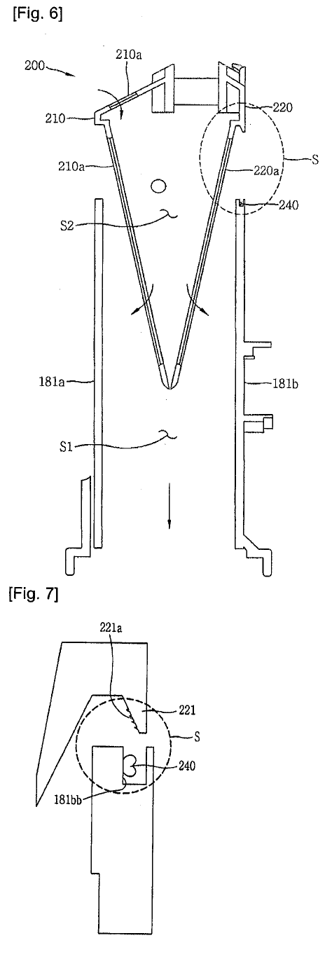

FIG. 4 is a front view showing the state that a filter is installed at a filter installation duct in FIG. 1, FIG. 5 is a side view showing the state that the filter is installed at the filter installation duct in FIG. 1, and FIG. 6 is a side cross-sectional view showing the state that the filter is installed at the filter installation duct in FIG. 1.

Referring to FIGS. 4 through 6, the filter installation duct 181 forms a space S1 where the filter 200 is installed by firmly connecting a front duct 181a and a rear duct 181b to each other. A blow opening 181aa is formed at the front duct 181a so as to introduce air coming out of the filter 200 to a fan installation duct 182. Also, side guides 181ab are formed at the front duct 181a so as to guide both sides of the filter 200 fitted therebetween.

The filter 200 forms a space S2 for collecting lint by firmly connecting a front frame 210 and a rear frame 220 to each other. A plurality of suction openings 210a, through which the air coming out of the drum 120 (referring to FIG. 1) is introduced into, are formed at an upper side of the front frame 210. At a lower side of the front frame 210 is disposed a front mesh 210b having a plurality of holes, through which lint-removed air is discharged. At a lower side of the rear frame 220 is disposed a rear mesh 220a having a plurality of holes, through which lint-removed air is discharged.

With such construction, if air containing lint coming out of the drum 120 (referring to FIG. 1) is introduced into the suction openings 210a, lint is filtered, thus to remain in the space S2. Then, the lint-removed air is discharged through the plurality of through-holes of the front and rear meshes 210b, 220b. The air thusly discharged from the through-holes is introduced into the fan installation duct 182 via the blow openings 181aa of the front duct 181b. The air introduced into the fan installation duct 182 is introduced into the heat exchanger 150 through the connection duct 183 to remove moisture, and then is discharged through the exhaust duct 161.

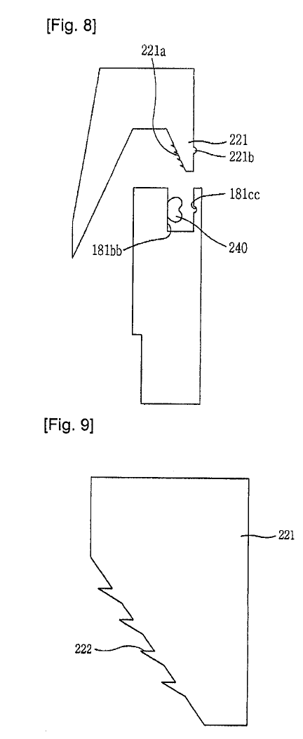

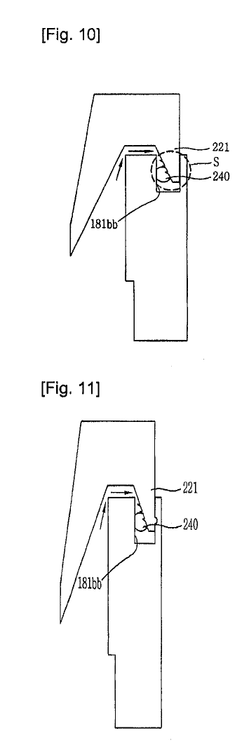

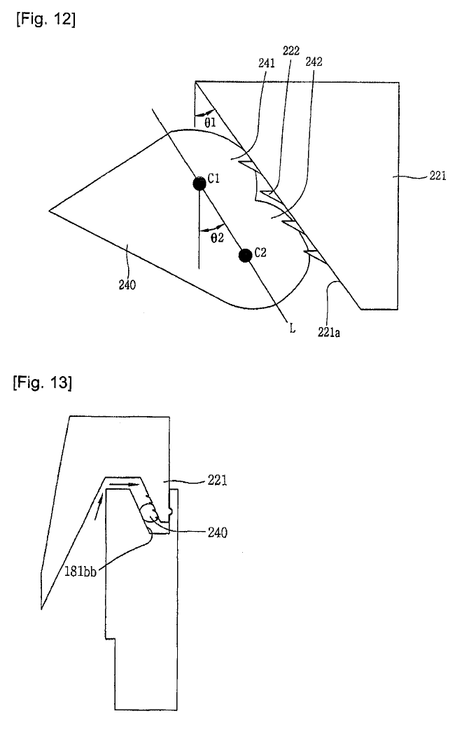

FIGS. 7 and 8 are an enlarged view showing a sealed portion of the filter installation duct and the filter in FIG. 6. FIG. 9 is an enlarged view showing a coupling protrusion in FIGS. 7 and 8. FIG. 10 is a view showing that the coupling protrusion is inserted into a coupling hole where a sealing member in FIG. 7 is installed. FIG. 11 is a view showing that the coupling protrusion is inserted into a coupling hole where a sealing member in FIG. 8 is installed. FIG. 12 is an enlarged view showing a state that the coupling protrusion contacts the sealing member in FIG. 7, and FIG. 13 is a view showing that an inclination surface is formed at the sealing hole according to another embodiment of the present invention.

Referring to FIGS. 7, 8 and 9, the sealing unit S includes a sealing protrusion 221 formed at the filter 200, a sealing recess 181bb formed at the rear duct 181b for inserting the sealing protrusion 221 thereinto, and a heart-shaped sealing member 240 inserted into the sealing recess 181bb and contacting the sealing protrusion 221. There may be provided with one or a plurality of the sealing members 240.

Here, the sealing protrusion of the sealing unit may be formed at the filter installation duct of the circulation duct, the sealing recess may be formed at the filter, and the sealing member may be provided between the sealing protrusion and the sealing recess. This changes only the position where the sealing protrusion and the sealing recess are formed, and its shape is similar. Hereinafter, description will be given in detail to the case that the sealing protrusion is formed at the filter, and the sealing recess is formed at the rear duct.

The sealing protrusion 221 protrudes from an upper end of the rear frame 220. The sealing protrusion 221 has an inclination surface 221a contacting the sealing member 240. Teeth 222 are formed on the inclination surface 221a.

Referring to FIG. 8, a protrusion portion 221b may be formed at the sealing protrusion 221, and a groove 181cc may be formed at the sealing recess 181bb. When the filter is installed, the protrusion portion 221b is fitted into the groove 181cc, thereby firmly mounting the sealing protrusion 221 to the sealing recess 181bb, thus to enhance the effect of preventing the leakage of lint.

Referring to FIGS. 10, 11 and 12, the sealing member 240 is provided with an upper protrusion portion 241 contacting the sealing protrusion 221 at an upper side thereof, and a lower protrusion portion 242 contacting the sealing protrusion 221 at a lower side thereof.

Here, an angle θ1 of a line L connecting a center C1 of the upper protrusion portion 241 and a center C2 of the lower protrusion portion 242 is the same as or greater than an inclination angle θ2 of the inclination surface 221a.

This is to completely prevent the leakage of lint by removing a gap, through which air flows, by greatly crushing the upper and lower protrusion portions 241, 242 when the upper and lower protrusion portions 241, 242 contact the sealing protrusion 221.

With such construction, when the sealing protrusion 221 is inserted into the sealing recess 181bb, the upper protrusion portion 241 and the lower protrusion portion 242 respectively contact the inclination surface 221a of the sealing protrusion 221. Here, the upper and lower protrusion portions 241, 242 contact the teeth 222 again, thereby more firmly preventing the leakage of lint.

That is, even though air containing lint tries to be discharged from the sealing unit in a direction of arrows shown in FIGS. 10 and 11, due to the structure of the sealing unit preventing the leakage of lint, the air containing lint cannot be discharged from the sealing unit.

Referring to FIG. 13, when the sealing protrusion 221 is inserted into the sealing recess 181bb, an inclination surface may be formed on the surface of the sealing recess facing the inclination surface 221a of the sealing protrusion 221. With such inclination surface, the effect of preventing the leakage of lint may greatly increase between the sealing protrusion 221 and the sealing recess 181bb.

### Effect of the Invention

The ductless dryer according to the present invention can prevent the leakage of lint through a gap of the filter installation portion due to the sealing unit for preventing the leakage of lint through the gap of the filter installation portion, and also can prevent the malfunction of the ductless dryer due to the leaked lint, thereby enhancing its reliability, thus to be used in a dryer industry.

1. A ductless dryer, comprising:
a main body;
a drum rotatably mounted at the main body;
a hot air supplying unit for supplying hot air into the drum;
a heat exchanger for removing moisture contained in air exhausted from the drum;
a circulation duct conducting the air exhausted from the drum to the heat exchanger;
a filter installed in the circulation duct for filtering lint contained in the air discharged from the drum; and
a sealing unit disposed between the filter and the circulation duct for preventing a leakage of lint through a gap of an installation portion where the filter is installed.

2. The ductless dryer of claim 1, wherein the sealing unit comprises:
a sealing protrusion formed at the filter;
a sealing recess disposed at a filter installation duct of the circulation duct for inserting the sealing protrusion thereinto; and
a sealing member disposed between the sealing protrusion and the sealing recess when the sealing protrusion is inserted into the sealing recess.

3. The ductless dryer of claim 1, wherein the sealing unit comprises:
a sealing protrusion formed at the filter installation duct of the circulation duct;
a sealing recess disposed at the filter for inserting the sealing protrusion thereinto; and
a sealing member disposed between the sealing protrusion and the sealing recess when the sealing protrusion is inserted into the sealing recess.

4. The ductless dryer of claim 2, wherein the sealing member is mounted at the sealing protrusion.

5. The ductless dryer of claim 2, wherein the sealing member is mounted at the sealing recess.

6. The ductless dryer of claim 2, wherein the sealing protrusion has an inclination surface contacting the sealing member.

7. The ductless dryer of claim 2, wherein one or a plurality of the sealing members are provided.

8. The ductless dryer of claim 6, wherein teeth are formed on the inclination surface.

9. The ductless dryer of claim 6, wherein an inclination surface is formed on a surface of the sealing recess facing the inclination surface of the sealing protrusion.

10. The ductless dryer of claim 2, wherein a protrusion portion is formed at the sealing protrusion, and a groove is formed at the sealing recess, thereby fitting the protrusion portion into the groove and mounting the sealing protrusion to the sealing recess.

11. The ductless dryer of claim 2, wherein the sealing member is provided with an upper protrusion portion contacting the sealing protrusion at an upper side thereof, and a lower protrusion portion contacting the sealing protrusion at a lower side thereof.

12. The ductless dryer of claim 11, wherein the sealing protrusion has an inclination surface contacting the sealing member, and an inclination angle of a line connecting each center of the upper protrusion portion and the lower protrusion portion is the same as or greater than an inclination angle of the inclination surface.

13. The ductless dryer of claim 3, wherein the sealing member is mounted at the sealing protrusion.

14. The ductless dryer of claim 3, wherein the sealing member is mounted at the sealing recess.

15. The ductless dryer of claim 3, wherein the sealing protrusion has an inclination surface contacting the sealing member.

16. The ductless dryer of claim 4, wherein the sealing protrusion has an inclination surface contacting the sealing member.

17. The ductless dryer of claim 5, wherein the sealing protrusion has an inclination surface contacting the sealing member.

18. The ductless dryer of claim 6, wherein one or a plurality of the sealing members are provided.

19. The ductless dryer of claim 7, wherein teeth are formed on the inclination surface.

20. The ductless dryer of claim 7, wherein an inclination surface is formed on a surface of the sealing recess facing the inclination surface of the sealing protrusion.
